(19) United States
(12) Patent Application Publication
(10) Pub. No.: US 2026/0369459 A1
(43) Pub. Date: Nov. 19, 2026

(54) INDUCTOR STRUCTURE

(71) Applicant: TAI-TECH ADVANCED ELECTRONICS CO., LTD., Taoyuan City (TW)

(72) Inventors: Kuan-Yi LU, Taoyuan City (TW); Cheng-Han YU, Taoyuan City (TW); Ming-Yen HSIEH, Taoyuan City (TW)

(21) Appl. No.: 19/096,653

(22) Filed: Mar. 31, 2025

(51) Int. Cl. H01F 27/28

(52) U.S. Cl. CPC H01F 27/2847

(57) ABSTRACT

The inductor structure includes a housing, and a coil. The coil is at least partially placed inside the housing. The coil includes a top section and two leg sections. The top section has its two ends respectively connected to the leg sections. The top section has two first side edges, and the lateral distance therebetween is defined as a first width. The leg sections have two second side edges, and the lateral distance therebetween is defined as a second width. The first width is not equal to the second width. When the first width is not equal to the second width, the magnetic field intensity in a specific region of the coil is enhanced, causing the magnetic field lines in that region to become more concentrated. This increases the inductive effect in the specific region, thereby increasing the inductance value of the inductor structure.

### BACKGROUND OF THE INVENTION

### (a) Technical Field of the Invention

The present invention generally relates to inductors, and more particularly to an inductor structure with enhanced inductance value.

### (b) Description of the Prior Art

Please refer to FIG. 4, which depicts a conventional inductor structure. It includes a housing 4 and a coil 5, where the coil 5 is placed inside the housing 4. The coil 5 includes a top section 51 and two leg sections 52. The two ends of the top section 51 are respectively connected to the two leg sections 52. The top section 51 has two first side edges 511, and the lateral distance between these two first side edges 511 is defined as the first width D5. The leg sections 52 have two second side edges 521, and the lateral distance between these two second side edges 521 is defined as the second width D6. The first width D5 is equal to the second width D6.

When the permeability of the coil 5 is 43 H/m (Henries per meter), and the first width D5 of the top section 51 is 2.4 mm, while the second width D6 of the leg sections 52 is 2.4 mm, the inductance value is 68.786 nH (nanoHenries), and the DC resistance is 0.15279 mΩ (milliohms).

Additionally, when the permeability of the coil 5 is 60 H/m, with the first width D5 of the top section 51 still at 2.4 mm and the second width D6 of the leg sections 52 also at 2.4 mm, the inductance value increases to 94.629 nH, while the DC resistance remains at 0.15279 mΩ.

The increase in inductance value provides the following advantages:
1. Enhanced Filtering Performance: Increasing the inductance value improves the performance of filters.
2. Higher Energy Storage Capability: The energy storage capacity of an inductor is proportional to its inductance value. A higher inductance allows the inductor to store more magnetic energy.
3. Reduction of Current Fluctuations: In power filtering circuits or power regulation circuits, increasing the inductance value helps to reduce current fluctuations and pulses, thereby minimizing power loss.
4. Improved Circuit Stability: A higher inductance value enables the circuit to respond more smoothly to load variations, ensuring a more stable current supply for rapidly changing load demands.
5. Beneficial for Power Management Systems: In power management and conversion systems, increasing the inductance value can improve energy transfer efficiency and reduce energy losses.

### SUMMARY OF THE INVENTION

Therefore, the present invention discloses a new structure that can improve the inductor within the same length and height constraints to achieve a higher inductance value.

To achieve the above objective, the inductor structure includes a housing, and a coil at least partially placed inside the housing. The coil includes a top section and two leg sections. The top section has its two ends respectively connected to the two leg sections. The top section has two first side edges. A lateral distance between these two first side edges is defined as a first width. The leg sections have two second side edges. A lateral distance between these two second side edges is defined as a second width. The first width is not equal to the second width.

Specifically, the first width is smaller than the second width.

Specifically, the coil is a flat coil.

Specifically, the coil further includes two bottom sections respectively connected to the two leg sections.

Specifically, the coil further includes two bottom sections respectively connected to the two leg sections. The two bottom sections have two third side edges. A lateral distance between these two third side edges is defined as a third width. The first width is smaller than the second width, and the third width is equal to the second width.

As such, a coil of the same length where its first width is not equal to the second width can enhance the magnetic field intensity in a specific region, causing the magnetic field lines to become more concentrated in that region. This, in turn, increases the inductive effect in the specific region. Additionally, since the DC resistance of the coil is related to its cross-sectional area, a reduction in the coil's cross-sectional area in the specific region will result in an increase in DC resistance in that area. This achieves the dual purpose of enhancing the inductance value while causing a slight increase in DC resistance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an inductor structure according to a first embodiment of the present invention.

FIG. 2 is a perspective diagram showing an inductor structure according to a second embodiment of the present invention.

FIG. 3 depicts that an inductor structure according to the present invention is configured on a circuit board.

FIG. 4 is a perspective diagram showing a conventional inductor structure.

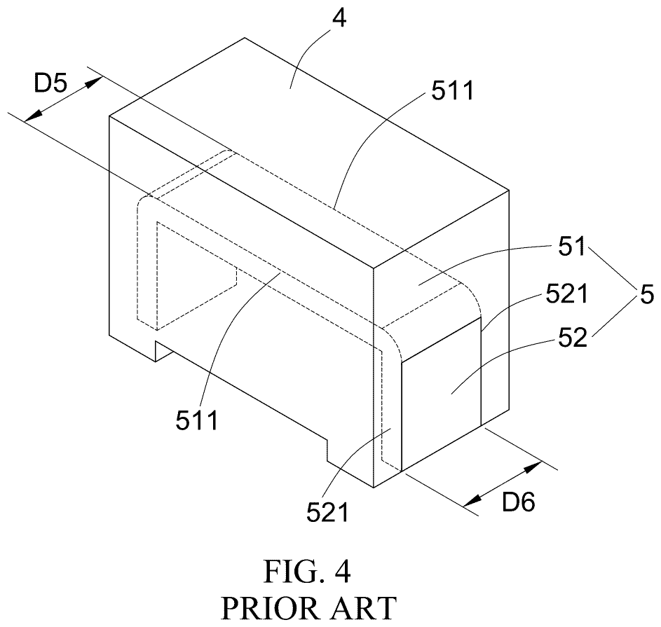

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

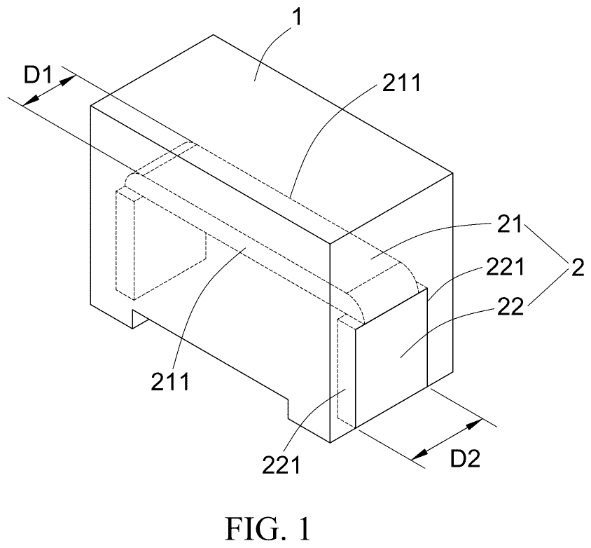

As shown in FIG. 1, an inductor structure according to a first embodiment of the present invention includes the following components.

A housing 1 is used to protect other components housed inside and prevent external factors such as moisture and dust from affecting the performance of the inductor structure.

A coil 2 is at least partially placed inside the housing 1. The coil 2 include a top section 21 and two leg sections 22. The two ends of the top section 21 are respectively connected to the two leg sections 22. The top section 21 has two first side edges 211, and the lateral distance between these two first side edges 211 is defined as a first width D1. The leg sections 22 have two second side edges 221, and the lateral distance between these two second side edges 221 is defined as a second width D2. The first width D1 is not equal to the second width D2, with the first width D1 being smaller than the second width D2. At least a portion of the coil 2 is positioned inside the housing 1. For example, the main part of the coil 2 may be inside the housing 1, while the lead pins extending and bending outward from the coil 2 may be located outside the housing 1. However, the present invention is not limited to this configuration. The coil 2 may be a flat coil.

When the permeability of coil 2 is 43 H/m (Henries per meter), the first width D1 of the top section 21 is 1.8 mm (millimeters), and the second width D2 of the leg sections 22 is 2.4 mm, the inductance value is 83.479 nH (nanoHenries), and the DC resistance is 0.18339 mΩ (milliohms).

Compared to a conventional inductor whose inductance value is 68.786 nH, and the DC resistance is 0.15279 mΩ, the present embodiment has the inductance value 83.479 nH, and the DC resistance 0.18339 mΩ.

The inductance value increase ratio by the present embodiment is calculated as (83.479−68.786)/68.786×100%=21%. The DC resistance increase ratio is (0.18339−0.15279)/0.15279×100%=20%.

On the other hand, when the permeability of coil 2 is 60 H/m, with the first width D1 of the top section 21 at 1.8 mm and the second width D2 of the leg sections 22 at 2.4 mm, the inductance value is 115.23 nH, and the DC resistance is 0.18339 mΩ.

Compared to a conventional inductor whose inductance value is 94.629 nH, and the DC resistance is 0.15279 mΩ, the present embodiment has the inductance value 115.23 nH, and the DC resistance 0.18339 mΩ.

The inductance value increase ratio by the present embodiment is calculated as (115.23−94.629)/94.629×100%=21%. The DC resistance increase ratio is (0.18339−0.15279)/0.15279×100%=20%.

Thus, by utilizing the unequal-width structure of coil 2, under the same length and height conditions, when the first width D1 is smaller than the second width D2, the inductance value can be increased.

Additionally, the relationship between the cross-sectional area of coil 2 and its DC resistance can be understood through the resistance formula. According to Ohm's Law, the formula is as follows: R=ρ(L/A), where R is the resistance (unit: ohms, Ω), ρ is the resistivity of the coil (unit: Ω·m), L is the length of the coil (unit: meters, m), and A is the cross-sectional area of the coil (unit: square meters, m²). From the formula, it can be observed that when the cross-sectional area of coil 2 decreases (as the width decreases, the cross-sectional area also decreases), its DC resistance increases.

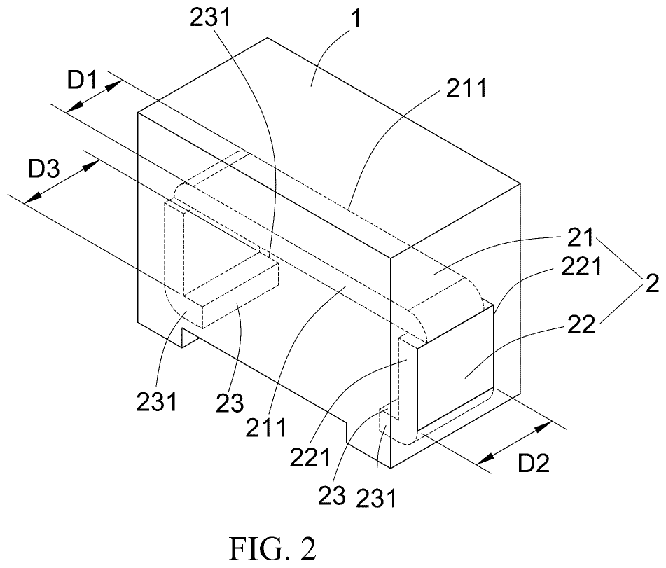

As shown in FIG. 2, an inductor structure according to a second embodiment of the present invention differs from the previous embodiment in that coil 2 also includes two bottom sections 23, which are respectively connected to the two leg sections 22. Additionally, the two bottom sections 23 have two third side edges 231, and the lateral distance between these two third side edges 231 is defined as the third width D3. The first width D1 is smaller than the second width D2, and the third width D3 is equal to the second width D2. The rest of the structure remains the same as in the previous embodiment and will not be described again.

When the permeability of coil 2 is 43 H/m, the first width D1 of the top section 21 is 1.8 mm, the second width D2 of the leg sections 22 is 2.4 mm, and the third width D3 of the bottom sections 23 is 2.4 mm. Under these conditions, the inductance value is 83.187 nH, and the DC resistance is 0.17955 mΩ.

Compared to a conventional inductor whose inductance value is 68.786 nH, and the DC resistance is 0.15279 mΩ, the present embodiment has the inductance value 83.187 nH, and the DC resistance 0.17955 mΩ.

The inductance value increase ratio by the present embodiment is calculated as (83.187−68.786)/68.786×100%=21%. The DC resistance increase ratio is (0.17955−0.15279)/0.15279×100%=17.5%.

On the other hand, when the permeability of coil 2 is 60 H/m, with the first width D1 of the top section 21 at 1.8 mm, the second width D2 of the leg sections 22 at 2.4 mm, and the third width D3 of the bottom sections 23 at 2.4 mm, the inductance value is 114.853 nH, and the DC resistance is 0.17955 mΩ.

Compared to a conventional inductor whose inductance value is 94.629 nH, and the DC resistance is 0.15279 mΩ, the present embodiment has the inductance value 114.853 nH, and the DC resistance 0.17955 mΩ.

The inductance value increase ratio by the present embodiment is calculated as (114.853−94.629)/94.629×100%=21%. The DC resistance increase ratio is (0.17955−0.15279)/0.15279×100%=17.5%.

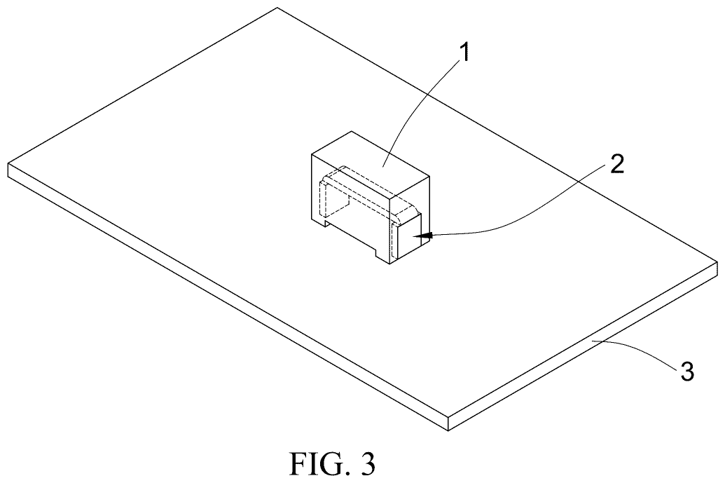

As shown in FIG. 3, the inductor structure of the present invention is configured on a circuit board 3.

When the first width D1 is not equal to the second width D2, and the first width D1 is smaller than the second width D2, the magnetic field intensity in a specific region of coil 2 is enhanced, causing the magnetic field lines in that region to become more concentrated. This increases the inductive effect in the specific region. Additionally, since the DC resistance of coil 2 is related to its cross-sectional area, a reduction in the cross-sectional area in a specific region of coil 2 results in an increase in DC resistance in that area. This design achieves the goal of increasing the inductance value while causing only a slight increase in DC resistance. Furthermore, coil 2 also includes two bottom sections 23. By utilizing the third width D3 of the bottom sections 23, where the first width D1 is smaller than the second width D2 and the third width D3 is equal to the second width D2, the same effect of increasing the inductance value while slightly increasing DC resistance can be achieved. In fact, the inclusion of two bottom sections 23 alone can slightly increase the inductance value. However, when the first width D1 is smaller than the second width D2, and the third width D3 is equal to the second width D2, the effect becomes more significant.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An inductor structure, comprising:
a housing; and
a coil at least partially placed inside the housing, where the coil comprises a top section and two leg sections, the top section has its two ends respectively connected to the two leg sections, the top section has two first side edges, a lateral distance between these two first side edges is defined as a first width, the leg sections have two second side edges, a lateral distance between these two second side edges is defined as a second width;
wherein the first width is not equal to the second width.

2. The inductor structure according to claim 1, wherein the first width is smaller than the second width.

3. The inductor structure according to claim 1, wherein the coil is a flat coil.

4. The inductor structure according to claim 1, wherein the coil further comprises two bottom sections respectively connected to the two leg sections.

5. The inductor structure according to claim 1, wherein the coil further comprises two bottom sections respectively connected to the two leg sections; the two bottom sections have two third side edges; a lateral distance between these two third side edges is defined as a third width; the first width is smaller than the second width; and the third width is equal to the second width.
